(19) United States
(12) Patent Application Publication
(10) Pub. No.: US 2008/0042970 A1
(43) Pub. Date: Feb. 21, 2008

(54) Associating a region on a surface with a sound or with another region

(76) Inventors: Yih-Shiuan Liang, Emeryville, CA (US); Judah Menter, San Francisco, CA (US); Mari Sunderland, Alameda, CA (US); Sulivan Parker, San Francisco, CA (US)

Correspondence Address: WAGNER, MURABITO & HAO LLP, Third Floor, Two North Market Street, San Jose, CA, 95113, US

(21) Appl. No.: 11/492,267

(22) Filed: Jul. 24, 2006

(51) Int. Cl. G09G 5/00

(52) U.S. Cl. 345/156

(57) ABSTRACT

A surface that includes a pattern of markings that define spatial coordinates on the surface is scanned. The pattern of markings is decoded to define a region on the surface. Additional information is associated with the region. For example, a sound may be associated with the region such that, when the region is subsequently scanned, the sound may be audible. In another example, a second region on the same or on a different surface may be associated with the first region.

### BACKGROUND

Devices such as optical readers or optical pens conventionally emit light that reflects off a surface to a detector or imager. As the device is moved relative to the surface (or vice versa), successive images are rapidly captured. By analyzing the images, movement of the optical device relative to the surface can be tracked.

One type of optical pen is used with a sheet of paper on which very small dots are printed—the paper can be referred to as encoded paper or more generally as encoded media. The dots are printed on the page in a pattern with a nominal spacing of about 0.3 millimeters (0.01 inches). The pattern of dots within any region on the page is unique to that region. The optical pen essentially takes a snapshot of the surface, perhaps 100 times or more a second. By interpreting the dot positions captured in each snapshot, the optical pen can precisely determine its position relative to the page.

The combination of optical pen and encoded media provides advantages relative to, for example, a conventional laptop or desktop computer system. For example, as a user writes on encoded paper using the pen's writing instrument, the handwritten user input can be captured and stored by the pen. In this manner, pen and paper provide a cost-effective and less cumbersome alternative to the paradigm in which a user inputs information using a keyboard and the user input is displayed on a monitor of some sort.

### SUMMARY

A device that permits new and different types of interactions between user, pen and media (e.g., paper) would be advantageous. Embodiments in accordance with the present invention provide such a device, as well as methods and applications that can be implemented using such a device.

In one embodiment, using the device, a region is defined on an item of encoded media (e.g., on a piece of encoded paper). A sound is then associated with that region. When the region is subsequently scanned, the sound is rendered.

Any type of sound can be associated with a region. For example, a sound such as, but not limited to, a word or phrase, music, or some type of “sound effect” (any sound other than voice or music) can be associated with a region (the same sound can also be associated with multiple regions). The sound may be pre-recorded or it may be synthesized (e.g., using text-to-speech or phoneme-to-speech synthesis). For example, a user may write a word on encoded paper and, using a character recognition process, the written input can be matched to a pre-recorded version of the word or the word can be phonetically synthesized.

The content of a region may be handwritten by a user, or it may be preprinted. Although the sound associated with a region may be selected to evoke the content of the region, the sound is independent of the region's content (other than the encoded pattern of markings within the region). Thus, the content of a region can be changed without changing the sound associated with the region, or the sound can be changed without changing the content.

Also, the steps of adding content to a region and associating a sound with that region can be separated by any amount of time. Thus, for example, a user can take notes on an encoded piece of paper, and then later annotate those notes with appropriate auditory cues.

As mentioned above, once a sound is associated with a region, that sound can be played back when the region is subsequently scanned by the device. Alternatively, a sound can be triggered without scanning a region, and a user can be prompted to use the device to locate the region that is associated with the sound. Thus, for example, the device can be used for quizzes or games in which the user is supposed to correctly associate content with a rendered sound.

In another embodiment, a region defined on an item of encoded media can be associated with another region that has been similarly defined on the same or on a different item of media content (e.g., on the same or different pieces of paper). In much the same way that the content of a region can be associated with a sound as described above, the content of one region can be associated with the content of another region.

In summary, according to embodiments of the present invention, a user can interact with a device (e.g., an optical pen) and input media (e.g., encoded paper) in new and different ways, enhancing the user's experience and making the device a more valuable tool. These and other objects and advantages of the present invention will be recognized by one skilled in the art after having read the following detailed description, which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a device upon which embodiments of the present invention can be implemented.

FIG. 2 illustrates a portion of an item of encoded media upon which embodiments of the present invention can be implemented.

FIG. 3 illustrates an example of an item of encoded media with added content in an embodiment according to the present invention.

FIG. 4 illustrates another example of an item of encoded media with added content in an embodiment according to the present invention.

FIG. 5 is a flowchart of one embodiment of a method in which a region of encoded media and a sound are associated according to the present invention.

FIG. 6 is a flowchart of one embodiment of a method in which regions of encoded media are associated with each other according to the present invention.

### DETAILED DESCRIPTION OF THE INVENTION

In the following detailed description of the present invention, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

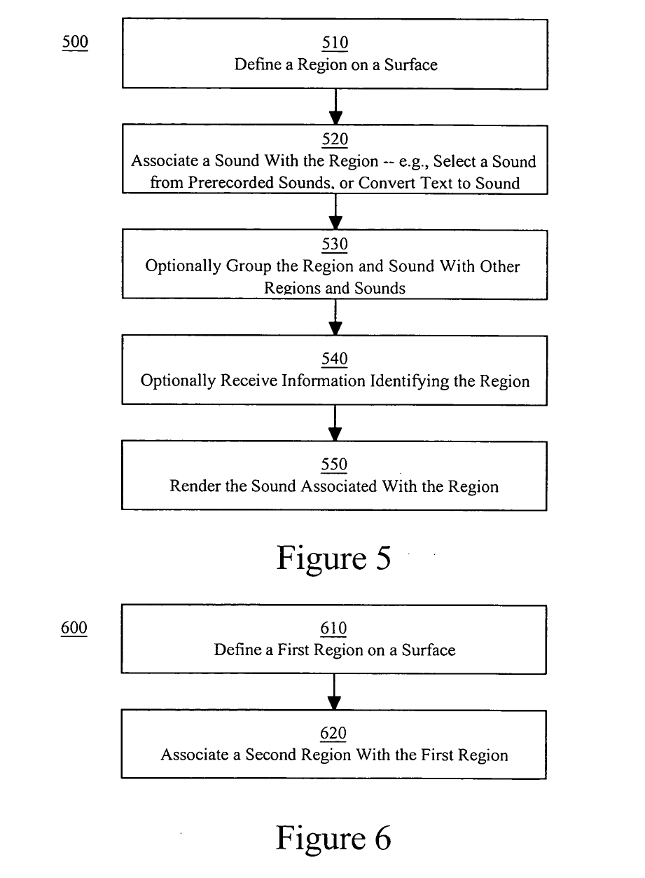

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “sensing” or “scanning” or “storing” or “defining” or “associating” or “receiving” or “selecting” or “generating” or “creating” or “decoding” or “invoking” or “accessing” or “retrieving” or “identifying” or “prompting” or the like, refer to the actions and processes of a computer system (e.g., flowcharts 500 and 600 of FIGS. 5 and 6, respectively), or similar electronic computing device, that manipulates and transforms data represented as physical (electronic) quantities within the computer system's registers and memories into other data similarly represented as physical quantities within the computer system memories or registers or other such information storage, transmission or display devices.

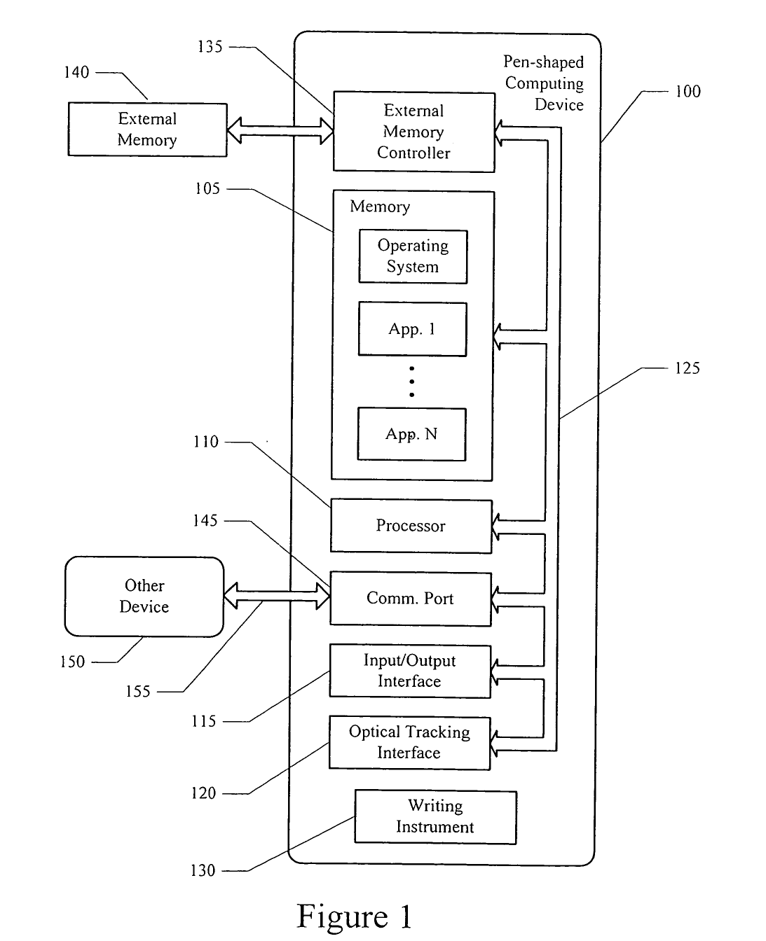

FIG. 1 is a block diagram of a computing device 100 upon which embodiments of the present invention can be implemented. In general, device 100 may be referred to as a pen-shaped computer system or an optical device, or more specifically as an optical reader, optical pen or digital pen. In general, device 100 may have a form factor similar to a pen, stylus or the like.

Devices such as optical readers or optical pens emit light that reflects off a surface to a detector or imager. As the device is moved relative to the surface (or vice versa), successive images are rapidly captured. By analyzing the images, movement of the optical device relative to the surface can be tracked.

According to embodiments of the present invention, device 100 is used with a sheet of “digital paper” on which a pattern of markings—specifically, very small dots—are printed. Digital paper may also be referred to herein as encoded media or encoded paper. In one embodiment, the dots are printed on paper in a proprietary pattern with a nominal spacing of about 0.3 millimeters (0.01 inches). In one such embodiment, the pattern consists of 669,845,157,115,773,458,169 dots, and can encompass an area exceeding 4.6 million square kilometers, corresponding to about 73 trillion letter-size pages. This “pattern space” is subdivided into regions that are licensed to vendors (service providers)—each region is unique from the other regions. In essence, service providers license pages of the pattern that are exclusively theirs to use. Different parts of the pattern can be assigned different functions.

An optical pen such as device 100 essentially takes a snapshot of the surface of the digital paper. By interpreting the positions of the dots captured in each snapshot, device 100 can precisely determine its position on the page in two dimensions. That is, in a Cartesian coordinate system, for example, device 100 can determine an x-coordinate and a y-coordinate corresponding to the position of the device relative to the page. The pattern of dots allows the dynamic position information coming from the optical sensor/detector in device 100 to be processed into signals that are indexed to instructions or commands that can be executed by a processor in the device.

In the example of FIG. 1, the device 100 includes system memory 105, a processor 110, an input/output interface 115, an optical tracking interface 120, and one or more buses 125 in a housing, and a writing instrument 130 that projects from the housing. The system memory 105, processor 110, input/output interface 115 and optical tracking interface 120 are communicatively coupled to each other by the one or more buses 125.

The memory 105 may include one or more well known computer-readable media, such as static or dynamic read only memory (ROM), random access memory (RAM), flash memory, magnetic disk, optical disk and/or the like. The memory 105 may be used to store one or more sets of instructions and data that, when executed by the processor 110, cause the device 100 to perform the functions described herein.

The device 100 may further include an external memory controller 135 for removably coupling an external memory 140 to the one or more buses 125. The device 100 may also include one or more communication ports 145 communicatively coupled to the one or more buses 125. The one or more communication ports can be used to communicatively couple the device 100 to one or more other devices 150. The device 110 may be communicatively coupled to other devices 150 by a wired communication link and/or a wireless communication link 155. Furthermore, the communication link may be a point-to-point connection and/or a network connection.

The input/output interface 115 may include one or more electro-mechanical switches operable to receive commands and/or data from a user. The input/output interface 115 may also include one or more audio devices, such as a speaker, a microphone, and/or one or more audio jacks for removably coupling an earphone, headphone, external speaker and/or external microphone. The audio device is operable to output audio content and information and/or receiving audio content, information and/or instructions from a user. The input/output interface 115 may include video devices, such as a liquid crystal display (LCD) for displaying alphanumeric and/or graphical information and/or a touch screen display for displaying and/or receiving alphanumeric and/or graphical information.

The optical tracking interface 120 includes a light source or optical emitter and a light sensor or optical detector. The optical emitter may be a light emitting diode (LED) and the optical detector may be a charge coupled device (CCD) or complementary metal-oxide semiconductor (CMOS) imager array, for example. The optical emitter illuminates a surface of a media or a portion thereof, and light reflected from the surface is received at the optical detector.

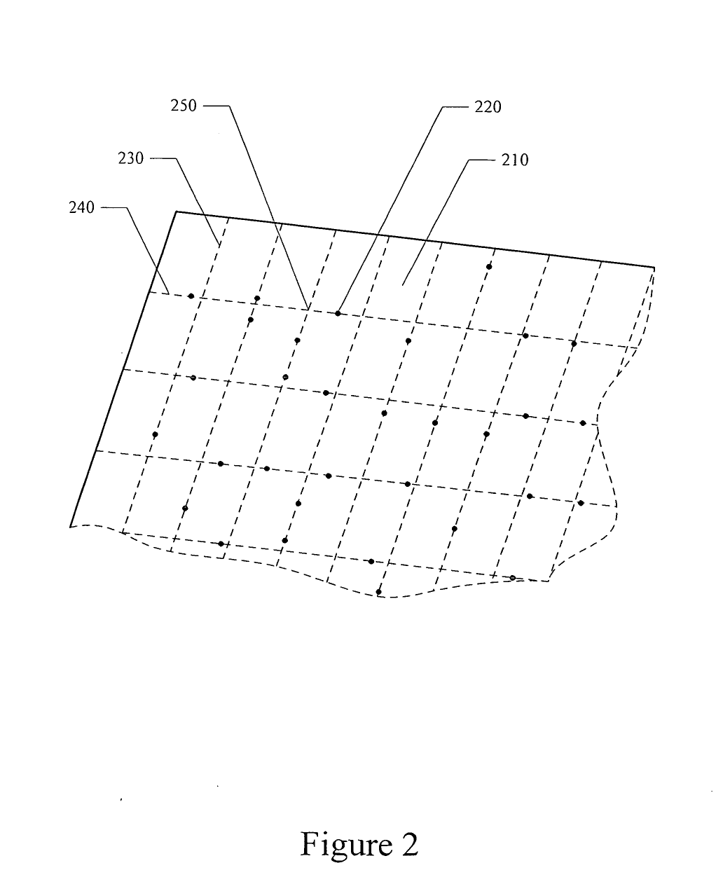

The surface of the media may contain a pattern detectable by the optical tracking interface 120. Referring now to FIG. 2, an example is shown of an item of encoded media 210, upon which embodiments according to the present invention can be implemented. Media 210 may be a sheet of paper, although surfaces consisting of materials other than, or in addition to, paper may be used. Media 210 may be a flat panel display screen (e.g., an LCD) or electronic paper (e.g., reconfigurable paper that utilizes electronic ink). Also, media 210 may or may not be flat. For example, media 210 may be embodied as the surface of a globe. Furthermore, media 210 may be smaller or larger than a conventional (e.g., 8.5×11-inch) page of paper. In general, media 210 can be any type of surface upon which markings (e.g., letters, numbers, symbols, etc.) can be printed or otherwise deposited, or media 210 can be a type of surface wherein a characteristic of the surface changes in response to action on the surface by device 100.

In one implementation, the media 210 is provided with a coding pattern in the form of optically readable position code that consists of a pattern of dots. As the writing instrument 130 and the optical tracking interface 120 move together relative to the surface, successive images are captured. The optical tracking interface 120 (specifically, the optical detector) can take snapshots of the surface 100 times or more a second. By analyzing the images, position on the surface and movement relative to the surface of the media can be tracked.

In one implementation, the optical detector fits the dots to a reference system in the form of a raster with raster lines 230 and 240 that intersect at raster points 250. Each of the dots 220 is associated with a raster point. For example, the dot 220 is associated with raster point 250. For the dots in an image, the displacement of a dot 220 from the raster point 250 associated with the dot 220 is determined. Using these displacements, the pattern in the image is compared to patterns in the reference system. Each pattern in the reference system is associated with a particular location on the surface. Thus, by matching the pattern in the image with a pattern in the reference system, the position of the device 100 (FIG. 1) relative to the surface can be determined.

With reference to FIGS. 1 and 2, by interpreting the positions of the dots 220 captured in each snapshot, the operating system and/or one or more applications executing on the device 100 can precisely determine the position of the device 100 in two dimensions. As the writing instrument and the optical detector move together relative to the surface, the direction and distance of each movement can be determined from successive position data.

In addition, different parts of the pattern of markings can be assigned different functions, and software programs and applications may assign functionality to the various patterns of dots within a respective region. Furthermore, by placing the optical detector in a particular position on the surface and performing some type of actuating event, a specific instruction, command, data or the like associated with the position can be entered and/or executed. For example, the writing instrument 130 may be mechanically coupled to an electro-mechanical switch of the input/output interface 115. Therefore, double-tapping substantially the same position can cause a command assigned to the particular position to be executed.

The writing instrument 130 of FIG. 1 can be, for example, a pen, pencil, marker or the like, and may or may not be retractable. In one or more instances, a user can use writing instrument 130 to make strokes on the surface, including letters, numbers, symbols, figures and the like. These user-produced strokes can be captured (e.g., imaged and/or tracked) and interpreted by the device 100 according to their position on the surface on the encoded media. The position of the strokes can be determined using the pattern of dots on the surface.

A user, in one implementation, uses the writing instrument 130 to create a character (e.g., an “M”) at a given position on the encoded media. The user may or may not create the character in response to a prompt from the computing device 100. In one implementation, when the user creates the character, device 100 records the pattern of dots that are uniquely present at the position where the character is created. The computing device 100 associates the pattern of dots with the character just captured. When computing device 100 is subsequently positioned over the “M,” the computing device 100 recognizes the particular pattern of dots associated therewith and recognizes the position as being associated with “M.” In effect, the computing device 100 recognizes the presence of the character using the pattern of markings at the position where the character is located, rather then by recognizing the character itself.

The strokes can instead be interpreted by the device 100 using optical character recognition (OCR) techniques that recognize handwritten characters. In one such implementation, the computing device 100 analyzes the pattern of dots that are uniquely present at the position where the character is created (e.g., stroke data). That is, as each portion (stroke) of the character “M” is made, the pattern of dots traversed by the writing instrument 130 of device 100 are recorded and stored as stroke data. Using a character recognition application, the stroke data captured by analyzing the pattern of dots can be read and translated by device 100 into the character “M.” This capability is useful for application such as, but not limited to, text-to-speech and phoneme-to-speech synthesis.

In another implementation, a character is associated with a particular command. For example, a user can write a character composed of a circled “M” that identifies a particular command, and can invoke that command repeatedly by simply positioning the optical detector over the written character. In other words, the user does not have to write the character for a command each time the command is to be invoked; instead, the user can write the character for a command one time and invoke the command repeatedly using the same written character.

In another implementation, the encoded paper may be preprinted with one or more graphics at various locations in the pattern of dots. For example, the graphic may be a preprinted graphical representation of a button. The graphics lies over a pattern of dots that is unique to the position of the graphic. By placing the optical detector over the graphic, the pattern of dots underlying the graphics are read (e.g., scanned) and interpreted, and a command, instruction, function or the like associated with that pattern of dots is implemented by the device 100. Furthermore, some sort of actuating movement may be performed using the device 100 in order to indicate that the user intends to invoke the command, instruction, function or the like associated with the graphic.

In yet another implementation, a user identifies information by placing the optical detector of the device 100 over two or more locations. For example, the user may place the optical detector over a first location and then a second location to specify a bounded region (e.g., a box having corners corresponding to the first and second locations). The first and second locations identify the information within the bounded region. In another example, the user may draw a box or other shape around the desired region to identify the information. The content within the region may be present before the region is selected, or the content may be added after the bounded region is specified.

Additional information is provided by the following patents and patent applications, herein incorporated by reference in their entirety for all purposes: U.S. Pat. No. 6,502,756; U.S. patent application Ser. No. 10/179,966 filed on Jun. 26, 2002; WO 01/95559; WO 01/71473; WO 01/75723; WO 01/26032; WO 01/75780; WO 01/01670; WO 01/75773; WO 01/71475; WO 01/73983; and WO 01/16691. See also Patent Application No. 60/456,053 filed on Mar. 18, 2003, and patent application Ser. No. 10/803,803 filed on Mar. 17, 2004, both of which are incorporated by reference in their entirety for all purposes.

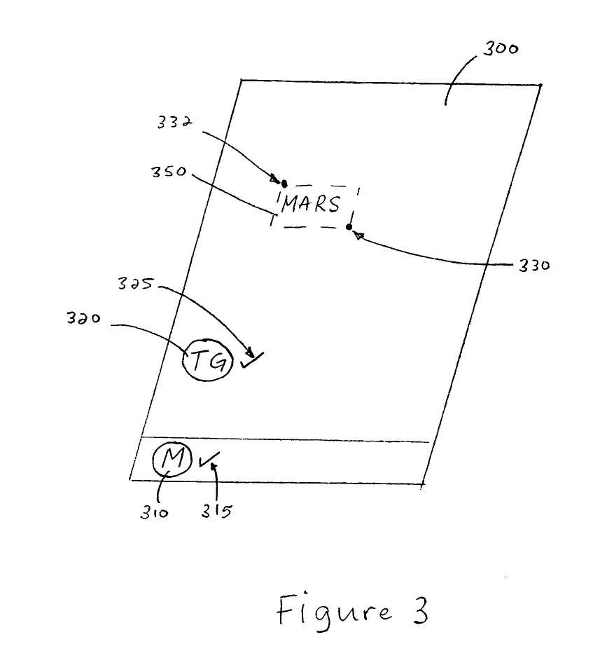

FIG. 3 illustrates an example of an item of encoded media 300 in an embodiment according to the present invention. Media 300 is encoded with a pattern of markings (e.g., dots) that can be decoded to indicate unique positions on the surface of media 300, as discussed above.

In the example of FIG. 3, graphic element 310 is preprinted on the surface of media 300. A graphic element may also be referred to as an icon. There may be more than one preprinted element on media 300. Associated with element 310 is a particular function, instruction, command or the like. As described previously herein, underlying the region covered by element 310 is a pattern of markings (e.g., dots) unique to that region. In one embodiment, a second element (e.g., a checkmark 315) is associated with element 310. Checkmark 315 is generally in proximity to element 310 to suggest a relationship between the two graphic elements.

By placing the optical detector of device 100 (FIG. 1) anywhere within the region encompassed by element 310, a portion of the underlying pattern of markings sufficient to identify that region is sensed and decoded, and the associated function, etc., may be invoked. In general, device 100 is simply brought in contact with any portion of the region encompassed by element 310 (e.g., element 310 is tapped with device 100) to invoke the corresponding function, etc. Alternatively, the function, etc., associated with element 310 may be invoked using checkmark 315 (e.g., by tracing, tapping or otherwise sensing checkmark 315), by double-tapping element 310, or by some other type of actuating movement.

There may be multiple levels of functions, etc., associated with a single graphic element such as element 310. For example, element 310 may be associated with a list of functions, etc.—each time device 100 scans (e.g., taps) element 310, the name of a function, command, etc., in the list is presented to the user. In one embodiment, the names in the list are vocalized or otherwise made audible to the user. To select a particular function, etc., from the list, an actuating movement of device 100 is made. In one embodiment, the actuating movement includes tracing, tapping, or otherwise sensing the checkmark 315 in proximity to element 310.

In the example of FIG. 3, a user can also activate a particular function, application, command, instruction or the like by using device 100 to draw elements such as graphic element 320 and checkmark 325 on the surface of media 300. In other words, a user can create handwritten graphic elements that function in the same way as the preprinted ones. The checkmark 325, in proximity to element 320, can be used as described above if there are multiple levels of commands, etc., associated with the element 320. The function, etc., associated with element 320 may be initially invoked simply by the act of drawing element 320, it may be invoked using checkmark 325, it may be invoked by double-tapping element 320, or it may be invoked by some other type of actuating movement.

A region 350 can be defined on the surface of media 300 by using device 100 to draw the boundaries of the region. Alternatively, a rectilinear region 350 can be defined by touching device 100 to the points 330 and 332 (in which case, lines delineating the region 350 are not visible to the user).

In the example of FIG. 3, the word “Mars” is handwritten by the user in region 350. The word “Mars” may be generally referred to herein as the content of region 350. That is, although region 350 also includes the pattern of markings described above in addition to the word “Mars,” for simplicity of discussion the term “content” may be used herein to refer to the information in a region that is in addition to the pattern of markings associated with that region.

Importantly, the content of region 350 can be created either before or after region 350 is defined. That is, for example, a user can first write the word “Mars” on the surface of media 300 (using either device 100 of FIG. 1 or any type of writing utensil) and then use device 100 to define a region that encompasses that content, or the user can first define a region using device 100 and then write the word “Mars” within the boundaries of that region (the content can be added using either device 100 or any type of writing utensil).

Although the content can be added using either device 100 or another writing utensil, adding content using device 100 permits additional functionality. In one embodiment, as discussed above, stroke data can be captured by device 100 as the content is added. Device 100 can analyze the stroke data to in essence read the added content. Then, using text-to-speech synthesis (TTS) or phoneme-to-speech synthesis (PTS), the content can be subsequently verbalized.

For example, the word “Mars” can be written in region 350 using device 100. As the word is written, the stroke data is captured and analyzed, allowing device 100 to recognize the word as “Mars.”

In one embodiment, stored on device 100 is a library of words along with associated vocalizations of those words. If the word “Mars” is in the library, device 100 can associate the stored vocalization of “Mars” with region 350 using TTS. If the word “Mars” is not in the library, device 100 can produce a vocal rendition of the word using PTS and associate the rendition with region 350. In either case, device 100 can then render (make audible) the word “Mars” when any portion of region 350 is subsequently sensed by device 100.

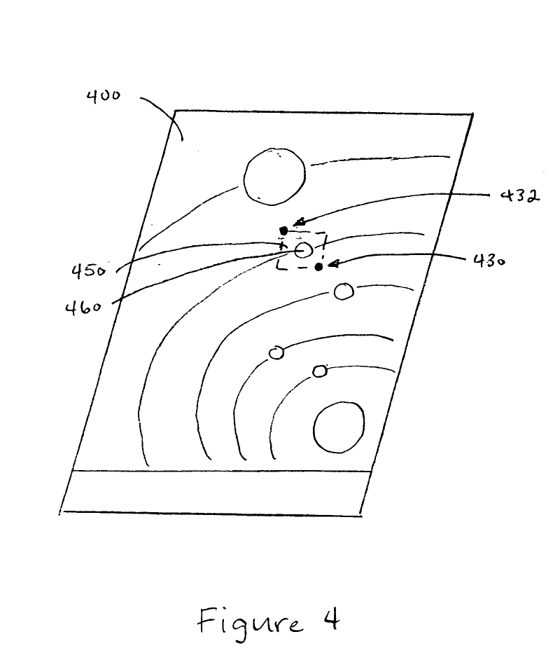

As will be seen by the example of FIG. 4, a sound associated with the content of region 350 can be associated with another region that is either on the same item of encoded media (e.g., on the same piece of encoded paper) or on another item of encoded media (e.g., on another piece of encoded paper). Furthermore, as will be described, sounds other than vocalizations of a word or phrase can also be associated with regions.

Alternatively, as will be seen, region 350 can be associated with another region that is either on the same item of encoded media (e.g., on the same piece of encoded paper) or on another item of encoded media (e.g., on another piece of encoded paper), such that the content of one region is essentially linked to the content of another region.

FIG. 4 illustrates another example of an item of encoded media 400 in an embodiment according to the present invention. Media 400 is encoded with a pattern of markings (e.g., dots) that can be decoded to indicate unique positions on the surface of media 400, as discussed above. Media 400 may also include preprinted graphic elements, as mentioned in conjunction with FIG. 3.

In the example of FIG. 4, a user has added content (e.g., a representation of a portion of the solar system) to media 400, using either the writing utensil of device 100 (FIG. 1) or some other type of writing utensil. Either at the time the content is created or at any time thereafter, device 100 of FIG. 1 can be used to define region 450 that encompasses some portion of the content (e.g., the element 460 representing the planet Mars). In one embodiment, region 450 is defined by touching the device 100 to the points 430 and 432 to define a rectilinear region that includes element 460. Alternatively, region 450 can be defined before the illustrated content is created, and the content can then be added to the region 450. Furthermore, because the region is defined according to the underlying pattern of markings and not according to the content, the content of region 450 can be changed after region 450 is defined. As another alternative, media 400 may be preprinted with content—for example, a preprinted illustration of the solar system may be produced on encoded media.

In one embodiment, the region 450 of FIG. 4 is associated with a particular sound. A sound may also be referred to herein as audio information. Also, the word “sound” is used herein in its broadest sense, and may refer to speech, music or other types of sounds (“sound effects” other than speech or music).

A sound may be selected from prerecorded sounds stored on device 100, or the sound may be a sound produced using TTS or PTS as described above. Prerecorded sounds can include sounds provided with the device 100 (e.g., by the manufacturer) or sounds added to the device by the user. The user may be able to download sounds (in a manner analogous to the downloading of ring tones to a cell phone or to the downloading of music to a portable music player), or to record sounds using a microphone on device 100.

For example, a vocalization of the word “Mars” may be stored on device 100, and a user can search through the library of stored words to locate “Mars” and associate it with region 450. Alternatively, the user can create a vocal rendition of the word “Mars” as described in conjunction with FIG. 3 and associate it with region 450. In one embodiment, the user may record a word or some other type of sound that is to be associated with region 450. For example, the user can announce the word “Mars” into a microphone on device 100—a voice file containing the word “Mars” is created on device 100 and associated with region 450.

Importantly, the steps of adding content to region 450 and associating a sound with that region can be separated by any amount of time, and can be performed in either order. For example, region 450 can be defined, then content can be added to region 450, and then a sound can associated with region 450. Alternatively, the content can be created, then region 450 can be defined, and then a sound can be associated with region 450. As yet another alternative, region 450 can be defined, then a sound can be associated with region 450, and then content can be added to region 450. At any point in time, either the content of region 450 or the sound associated with region 450 can be changed.

In one embodiment, multiple (different) sounds are associated with a single region such as region 450. In one such embodiment, the sound that is associated with region 450 and the sound that is subsequently rendered depends on, respectively, the application that is executing on device 100 (FIG. 1) when region 450 is created and the application that is executing on device 100 when region 450 is sensed by device 100.

In one embodiment, regions and their associated sounds can be grouped by the user, facilitating subsequent access. In general, the regions in the group are related in some manner, at least from the perspective of the user. For example, each planet in the illustration of FIG. 4 can be associated with a respective vocalization of the planet's name. Specifically, regions such as region 450 are defined for each planet, and a sound (e.g., a planet name) is associated with each region. The regions can be grouped and stored on device 100 under a user-assigned name (e.g., “solar system”). By subsequently accessing the group by its name, all of the regions in the group, and their associated sounds, can be readily retrieved.

An example is now provided to demonstrate how the features described above can be put to use. Although events in the example are described as occurring in a certain order, the events may be performed in a different order, as mentioned above. Also, although the example is described using at least two pieces of encoded media, a single piece of encoded media may be used instead.

In this example, a user has drawn a representation of the solar system as shown in FIG. 4, using either a conventional writing utensil or writing instrument 130 of device 100 (FIG. 1). Using device 100, the user launches an application that allows sounds and regions to be associated as described above. In one embodiment, the application is launched by using device 100 to draw an element (e.g., element 320) on encoded media 300 that corresponds to that application and performing some type of actuating movement, as previously described herein. In the example of FIG. 3, device 100 is programmed to recognize that the letters “TG” uniquely designate the application that associates sounds and regions.

In one embodiment, the application provides the user with a number of options. In one such embodiment, device 100 prompts the user to create a new group, load an existing group, or delete an existing group (where a group refers to grouped regions and associated sounds, mentioned in the discussion of FIG. 4 above). Other options may be presented to the user, such as a quiz mode described further below. In one embodiment, the prompts are audible prompts.

In one embodiment, the user scrolls through the various options by tapping device 100 in the region associated with element 320—with each tap, an option is presented to the user. The user selects an option using some type of actuating movement—for example, the user can tap checkmark 325 with device 100.

In this example, using device 100, the user selects the option to create a new group. The user can be prompted to select a name for the group. In one embodiment, in response to the prompt, the user writes the name of the group (e.g., solar system) on an item of encoded media, and device 100 uses the corresponding stroke data with TTS or PTS to create a verbal rendition of that name. Alternatively, the user can record the group name using a microphone on device 100.

Continuing with the implementation example, in one embodiment, device 100 prompts the user (e.g., using an audible prompt) to create additional graphic elements that can be used to facilitate the selection of the sounds that are to be associated with the various regions. For example, using device 100, the user is prompted to define a region containing the word “phrase” and a region containing the word “sound” on an item of encoded media. Actually, in one embodiment, these regions are independent of their respective content. From the perspective of device 100, two regions are defined, one of which is associated with a first function and the other associated with a second function. The device 100 simply associates the pattern of markings uniquely associated with those regions with a respective function. From the user's perspective, the content of those two regions serves as a cue to distinguish one region from the other and as a reminder of the functions associated with those regions.

In the example of FIG. 4, using device 100, a region 450 encompassing at least one of the elements (e.g., a planet) can be defined as previously described herein. Using device 100, the user selects either the “phrase” region or the “sound” region mentioned above. In this example, the user selects the “phrase” region. Using device 100, the user defines region 350 containing the word “Mars” as described above, and device 100 uses the corresponding stroke data with TTS or PTS to create a verbal rendition of “Mars.” Device 100 also automatically associates that verbal rendition with region 450, such that if region 450 is subsequently sensed by device 100, the word “Mars” can be made audible.

If instead the user selects the “sound” region using device 100, the user can be prompted to create other graphic elements that facilitate access to prerecorded sounds stored on device 100. For example, using device 100, a region containing the word “music” and a region containing the word “animal” can be defined on an item of encoded media. By tapping the “animal” region with device 100, different types of animal sounds can be made audible—with each tap, a different sound is made audible. A particular sound can be selected using some type of actuating movement. Device 100 also associates the selected sound with region 450, such that if region 450 is subsequently sensed by device 100, then the selected sound can be made audible.

Aspects of the process described in the example implementation above can be repeated for each element (e.g., each planet). In this manner, a group (e.g., solar system) containing a number of related regions (e.g., the regions associated with the planets) and sounds (e.g., the sounds associated with the regions in the group) can be created and stored on device 100.

The group can be subsequently loaded (accessed or retrieved) using the load option mentioned above. For example, to study and learn the planets in the solar system, a user can retrieved the stored solar system group from device 100 memory, and then use device 100 to sense the various regions defined on media 400. Each time a region (e.g., planet) on media 400 is sensed by device 100, the sound associated with that region (e.g., the planet's name) can be made audible, facilitating the user's learning process.

Once a group is created, device 100 can also be used to implement a game or quiz based on the group. For example, as mentioned above, the user can be presented with an option to place device 100 in quiz mode. In this mode, the user is prompted to select a group (e.g., solar system). Once a group is selected using device 100, then a sound associated with the group can be randomly selected and made audible by device 100. The user is prompted to identify the region that is associated with the audible sound. For example, device 100 may vocalize the word “Mars,” and if the user selects the correct region (e.g., region 450) in response, device 100 notifies the user; users can also be notified if they are incorrect.

In one embodiment, device 100 is capable of being communicatively coupled to, for example, another computer system (e.g., a conventional computer system or another pen-shaped computer system) via a cradle or a wireless connection, so that information can be exchanged between devices.

FIG. 5 is a flowchart 500 of one embodiment of a method in which a region of encoded media and a sound are associated according to the present invention. In one embodiment, with reference also to FIG. 1, flowchart 500 can be implemented by device 100 as computer-readable program instructions stored in memory 105 and executed by processor 110. Although specific steps are disclosed in FIG. 5, such steps are exemplary. That is, the present invention is well suited to performing various other steps or variations of the steps recited in FIG. 5.

In block 510 of FIG. 5, using device 100, a region is defined on a surface of an item of encoded media.

In block 520, a sound (audio information) is associated with the region. The sound may be prerecorded and stored, or the sound may be converted from text using TTS or PTS, for example.

In block 530, in one embodiment, the region and the sound associated therewith are grouped with other related regions and their respective associated sounds.

In block 540, in one embodiment, information is received that identifies the region. More specifically, the encoded pattern of markings that uniquely defines the region is sensed and decoded to identify a set of coordinates that define the region.

In block 550, the sound associated with the region is rendered. In one embodiment, the sound is rendered when the region is sensed. In another embodiment, the sound is rendered, and the user is prompted to find the region.

In another embodiment, a region (e.g. region 450 of FIG. 4) defined on an item of encoded media can be associated with another region (e.g., region 350 of FIG. 3) that has been similarly defined on the same or on a different item of media content (e.g., on the same or different pieces of paper). In much the same way that the content of a region can be associated with a sound as described above, the content of one region can be associated with the content of another region. Here, as opposed to the examples above, “content” refers both to the encoded pattern of markings within the respective regions and content in addition to those markings. For example, the regions can include hand-drawn or preprinted images or text. Thus, instead of associating a region and a sound, a region can in general be linked to other things, such as another region.

FIG. 6 is a flowchart 600 of one embodiment of a method in which a region of encoded media and another such region are associated with each other. In one embodiment, with reference also to FIG. 1, flowchart 600 can be implemented by device 100 as computer-readable program instructions stored in memory 105 and executed by processor 110. Although specific steps are disclosed in FIG. 6, such steps are exemplary. That is, the present invention is well suited to performing various other steps or variations of the steps recited in FIG. 6.

In block 610 of FIG. 6, a first region is defined using the optical device (e.g., device 100 of FIG. 1).

In block 620 of FIG. 6, the first region is associated with a second region that comprises a pattern of markings that define a second set of spatial coordinates. The first and second regions may be on the same or on different pages. The second region may be pre-defined or it may be defined using the optical device.

Thus, a first pattern of markings (those associated with the first region) and a second pattern of markings (those associated with the second region) are in essence linked. From another perspective, the content of the first region (in addition to the first pattern of markings) and the content of the second region (in addition to the second pattern of markings) are in essence linked.

Content added to a region (that is, content in addition to the pattern of markings within a region) may be handwritten by a user, or it may be preprinted. The first region may include, for example, a picture of the planet Mars and the second region may include, for example, the word “Mars.” Using device 100 of FIG. 1, a user may scan the second region and is prompted to find the region (e.g., the first region) that is associated with the second region, or vice versa. In the example, the user is thus prompted to match the first and second regions.

Features described in the examples of FIGS. 3 and 4 can be implemented in the example of FIG. 6. For instance, any amount of time may separate the times at which the various regions are defined, and the content of the various regions can be changed at any point in time.

Also, multiple regions can be associated with a single region. If a second region and a third region are both associated with a first region, for example, then the region that correctly matches the first region depends on the application being executed. For example, a first region containing the word “Mars” may be associated with a second region containing a picture of Mars and a third region containing the Chinese character for “Mars.” If a first application is executing on device 100 (FIG. 1), then in response to scanning of the first region with device 100, a user may be prompted to locate a picture of Mars, while if a second application is executing on device 100, then in response to scanning the first region with device 100, a user may be prompted to locate the Chinese character for “Mars.”

In summary, according to embodiments of the present invention, a user can interact with a device (e.g., an optical pen such as device 100 of FIG. 1) and input media (e.g., encoded paper) in new and different ways, enhancing the user's experience and making the device a more valuable tool.

Embodiments of the present invention are thus described. While the present invention has been described in particular embodiments, it should be appreciated that the present invention should not be construed as limited by such embodiments, but rather construed according to the below claims.

What is claimed is:

1. A method implemented by an optical device comprising a processor, memory and a light sensor, said method comprising:
defining a region on a surface using said optical device, wherein said region comprises a pattern of markings that define spatial coordinates on said surface; and
associating a sound with said region.

2. The method of claim 1 further comprising receiving a selection of said sound, wherein said selection is made from a sound stored on said optical device.

3. The method of claim 1 further comprising converting text into said sound.

4. The method of claim 1 wherein said sound is independent of content within said region other than said pattern of markings.

5. The method of claim 1 further comprising rendering said sound when said region is scanned using said optical device.

6. The method of claim 1 further comprising:
rendering said sound; and
prompting a user to locate said region in response to said rendering.

7. The method of claim 1 further comprising:
identifying a plurality of regions on said surface;
associating a plurality of sounds with said regions; and
associating said plurality of regions and said plurality of sounds as a group.

8. The method of claim 1 further comprising:
decoding portions of said pattern of markings to identify a set of coordinates; and
defining said region using said set of coordinates.

9. The method of claim 1 further comprising associating a second sound with said region.

10. A method implemented by an optical device comprising a processor, memory and a light sensor, said method comprising:
defining a first region using said optical device, wherein said first region comprises a pattern of markings that define a first set of spatial coordinates; and
associating said first region with a second region that comprises a pattern of markings that define a second set of spatial coordinates.

11. The method of claim 10 further comprising defining said second region using said optical device.

12. A device comprising:
an optical detector;
a processor coupled to said optical detector; and
a memory coupled to said processor, said memory unit containing instructions that when executed implement a method comprising:
sensing an encoded dot pattern on a surface with said optical detector, wherein said encoded dot pattern defines a set of spatial coordinates;
decoding said encoded dot pattern to define a region on said surface; and
associating a sound with said region, wherein said sound is audible if said encoded dot pattern is subsequently sensed and decoded.

13. The device of claim 12 wherein said sound is selected from a sound stored on said device.

14. The device of claim 12 wherein said sound is produced using text-to-speech synthesis.

15. The device of claim 12 wherein said sound is produced using phoneme-to-speech synthesis.

16. The device of claim 12 wherein said sound is independent of content within said region other than said encoded dot pattern.

17. The device of claim 12 wherein a user is prompted to locate said region in response to said sound made audible.

18. The device of claim 12 wherein said region and said sound are included in a group of related regions and sounds.

19. A computer-usable medium having computer-readable program code embodied therein for causing a pen-shaped computer system to perform a method comprising:
receiving information that defines a first region, wherein said first region comprises a pattern of markings that define a first set of spatial coordinates; and
associating said first region with a second region that comprises a pattern of markings that define a second set of spatial coordinates.

20. The computer-usable medium of claim 16 wherein said method further comprises receiving information that defines said second region.
